(19) United States
(12) Patent Application Publication
(10) Pub. No.: US 2018/0009392 A1
(43) Pub. Date: Jan. 11, 2018

(54) DEVICE FOR MOUNTING AUDIO SPEAKER IN VEHICLE AND MOUNTING CONSTRUCTION THEREOF

(71) Applicants: FUJITSU TEN LIMITED, Kobe-shi, Hyogo (JP); FUJITSU TEN MINDA INDIA PRIVATE LIMITED, Bawal, District, Rewari (Haryana) (IN)

(72) Inventors: Ryohei YOKOTA, Kobe-shi (JP); Yadav SANJAY, Waziprpur industrial area, New Delhi (IN); Ranjan Kumar RAVI, Waziprpur industrial area, New Delhi (IN)

(73) Assignees: FUJITSU TEN LIMITED, Kobe-shi, Hyogo (JP); FUJITSU TEN MINDA INDIA PRIVATE LIMITED, Bawal, District, Rewari (Haryana) (IN)

(21) Appl. No.: 15/547,426

(22) PCT Filed: Jan. 28, 2016
(86) PCT No.: PCT/JP2016/052553

§ 371 Date: Jul. 28, 2017

(30) Foreign Application Priority Data
Jan. 28, 2015 (IN) 242/DEL/2015

(51) Int. Cl. B60R 11/02; H04R 1/02

(52) U.S. Cl. CPC B60R 11/0217; H04R 1/025; H04R 2499/13; H04R 2400/11

(57) ABSTRACT

A device for mounting an audio speaker in a vehicle includes a clip and a pin. The clip includes an engaging plate, a first engager provided on a first side of the engaging plate, a first lock provided at an end of the first engager on an side opposite to the engaging plate, a second engager provided on a second side that is opposite to the first side of the engaging plate, and a second lock provided at an end of the second engager on a side opposite to the engaging plate. The pin includes a shaft and the first engager has a concave portion that receives the shaft of the pin.

### CROSS-REFERENCE TO RELATED APPLICATIONS

This application is a national stage application of International Application No. PCT/JP2016/052553 filed on Jan. 28, 2016, which designates the United States, which is herein incorporated by reference, and which is based upon and claims the benefit of priority to Indian provisional Patent Application No. 242/DEL/2015, filed on Jan. 28, 2015, the entire contents of which are herein incorporated by reference.

### FIELD

The present disclosure relates to a mounting device for mounting of an audio speaker(s) in a vehicle and a mounting construction thereof. More specifically, the disclosure relates to a mechanism of a mounting device for mounting an audio speaker(s) onto a body panel of a vehicle. More specifically, the disclosure relates to a mechanism of mounting an audio speaker(s) onto a body panel of a vehicle by means of a mounting device including a clip and a pin.

The disclosure also relates to a clip, a device for mounting an audio speaker in a vehicle, a method of mounting an audio speaker in a vehicle, a method of mounting a clip on an audio speaker, a method of removing an audio speaker from a vehicle, and a method of removing a clip from an audio speaker.

### BACKGROUND

Generally, a speaker is used as an audio output device in a vehicle, and has to be removably mounted on a body panel of a vehicle. Conventionally, ii is a general practice as illustrated in FIGS. 1, 2 and 3 to use an attaching construction for mounting a speaker on a plate. There are many techniques for facilitating mounting of a speaker onto a body panel of a vehicle such as direct screwing the speaker with a mounting panel on a vehicle body. FIG. 1, FIG. 2, and FIG. 3 illustrate techniques to mount a speaker to a body panel of a vehicle by using screwing. However, there are many demerits of this technique. One major shortcoming is a troublesome operation of fitment and removal of a speaker with a small tool being required for a fitment purpose.

Also due to repeated removal and installation, a thread on a screw as well as a corresponding groove wears out resulting in a loose connection leading to vibration between a speaker and a mounting panel.

However, to overcome these shortcomings, another technique of mounting a speaker was employed wherein a mounting screw was fastened by a metal nut at a bottom thereof. FIG, 2 illustrates a technique to mount a speaker on a body panel by using screwing and a metal nut. Eventually this led to an increase in a weight of a mounting construction due to usage of a metallic nut making it highly uneconomical.

Also, few solutions were developed whereby a mounting fixture was used to mount a speaker by means tightening with a screw at one end and fitting the fixture in a door/body panel at the other end by means of slant locks or locking ribs. FIG. 3 illustrates a technique to mount a speaker on a body panel by using a resin clip as a fixture. One end of a clip as illustrated in FIG. 3 is screw-fixed on a resin speaker frame. The other end of the clip is inserted into a mounting hole portion provided on a body panel and has slant locks or locking ribs that are fitted thereon by utilizing elasticity of the clip.

In a case where a clip as illustrated in FIG. 3 is used, a speaker can readily be mounted on a body panel by inserting slant locks or locking ribs of a clip mounted on a speaker frame into a mounting hole portion of the body panel without using another tool.

Furthermore, a screw hole for inserting a screw thereinto is provided at a center of a clip as illustrated in FIG. 3. Hence, water that intrudes between a body panel and a speaker can be drained to the exterior of a vehicle through a screw hole provided at a center of a clip.

Moreover, a speaker can be removed from a clip mounted on a body panel by removing a screw that fixes the clip on a speaker frame. Thus, it is possible to mount a speaker on a body panel or remove a speaker from a body panel (serviceability). However, this method too had a troublesome operation of screwing and an increased weight of a mounting construction.

That is, in a case where a clip is mounted on a speaker frame of a clip or a clip is removed from a speaker frame, a tool for mounting a screw on a clip or removing a screw from a clip, such as an electrical screwdriver has to be used.

Furthermore, in a case where a clip is mounted on a speaker frame, a screw is mounted on the clip, so that mass of a speaker is increased by mass of the screw that is used for the clip.

Moreover, a difference between a size of slant locks of a clip and a diameter of a mounting hole of a body panel is small, so that it may be difficult to insert the slant locks of the clip mounted on a speaker frame into the mounting hole of the body panel.

In other words, researchers are constantly working to develop a user friendly and technically advanced mounting construction for mounting a speaker onto a body panel of a vehicle. Furthermore, in other words, there always existed a need in the prior art to provide an alternative mounting construction and therefore the inventors of the present disclosure provide a user friendly and technically advanced mounting device for mounting a speaker onto a body panel of a vehicle.

More specifically, a mounting construction that is light in weight and economical and can hold a speaker in tight contact with a body panel of a vehicle is eliminating a problem like vibration.

### SUMMARY

A primary objective of the present invention is or accordingly it is an aim of the present disclosure to provide an improved device for mounting an audio speaker on a body panel of a vehicle to facilitate rigid contact.

Another objective of the present invention or another aim of the present disclosure is to provide an improved device and a mounting construction thereof enabling easy mounting and dismounting of a speaker for a body panel of a vehicle, thereby improving serviceability.

Yet another aim of the present disclosure is to provide an improved device and a mounting construction that provides a waterproofing function by draining water that enters in a vehicle compartment.

Yet another objective of the present invention or one more aim of the present disclosure is to provide an improved device for mounting an audio speaker on a body panel of a vehicle that is light in weight.

A mounting device for mounting an audio speaker including a mounting plate in a vehicle includes an engaging plate, a first engaging member disposed on a first side of the engaging plate, the first engaging member including a longitudinal threaded groove, and a second engaging member disposed on a second side of the engaging plate, the second engaging member including opposite locking ribs, the second engaging member including a channel.

A clip includes an engaging plate, a first engager provided on a first side of the engaging plate, a first lock provided at an end of the first engager on an side opposite to the engaging plate, a second engager provided on a second side that is opposite to the first side of the engaging plate, and a second lock provided at an end of the second engager on a side opposite to the engaging plate.

A device for mounting an audio speaker in a vehicle includes a clip and a pin. The pin includes a shaft and the first engager has a concave portion that receives the shaft of the pin.

### BRIEF DESCRIPTION OF DRAWINGS

Further aspects and advantages of or the present disclosure will be readily understood from the following detailed description with reference to the accompanying figures. The figures together with a detailed description below, are incorporated in and form part of the specification, and serve to further illustrate the embodiments and explain various principles and advantages, in accordance with the present disclosure, but not limiting the scope of the disclosure.

FIG. 1 illustrates a mounting arrangement employing direct screwing of a speaker with a body panel;

FIG. 2 illustrates another mounting arrangement of a speaker by direct screwing of the speaker with a body panel and use of a metal nut at a bottom thereof to secure a screw;

FIG. 3 is another prior art depicting a mounting fixture tightening with a screw in a speaker at one end of the fixture and a slant lock at the other end to fit a body panel;

FIG. 4 depicts a sectional view of a device for mounting an audio speaker in a vehicle, including a clip and a screw and a mounting construction thereof in accordance with the present disclosure, wherein a cushion has not been Used;

FIG. 5A and FIG. 5B illustrate a sectional view of a device for mounting an audio speaker in a vehicle, including a clip and a screw and a mounting construction thereof in accordance with the present disclosure, wherein a cushion has been used;

FIG. 6A, FIG. 6B, and FIG. 6C illustrate an isometric view of a device for mounting an audio speaker in a vehicle with respect to a clip and a screw according to an embodiment of the present disclosure;

FIG. 7 depicts a sectional view of a device for mounting an audio speaker in a vehicle, including a clip and a pin and a mounting construction thereof in accordance with the present disclosure, wherein a cushion has not been used;

FIG. 8A and FIG. 8B illustrate a sectional view of a device for mounting an audio speaker in a vehicle, including a clip and a pin and a mounting construction thereof in accordance with the present disclosure, wherein a cushion has been used;

FIG. 9A and FIG. 9B illustrate an isometric view of a device for mounting an audio speaker in a vehicle, in accordance with an embodiment of the present disclosure;

FIG. 10 illustrates a sectional view of a device for mounting an audio speaker in a vehicle, in accordance with another embodiment of the present disclosure;

FIG. 11 illustrates a sectional view of a device for mounting an audio speaker in a vehicle, in accordance with other embodiments of the present disclosure;

FIG. 12 illustrates a sectional view of a device for mounting an audio speaker in a vehicle, in accordance with yet another embodiment of the present disclosure;

FIG. 13 is a sectional view of a device for mounting an audio speaker in a vehicle according to yet another embodiment of the present disclosure;

FIG. 14A is a diagram that illustrates a method of mounting an audio speaker in a vehicle by using the device as illustrated in FIG. 13;

FIG. 14B is a diagram that illustrates a method of mounting an audio speaker in a vehicle by using the device as illustrated in FIG. 13;

FIG. 14C is a diagram that illustrates a method of mounting an audio speaker in a vehicle by using the device as illustrated in FIG. 13;

FIG. 14D is a diagram that illustrates a method of mounting an audio speaker in a vehicle by using the device as illustrated in FIG. 13;

FIG. 15A is a diagram that illustrates a method of removing an audio speaker from a vehicle by using the device as illustrated in FIG. 13;

FIG. 15B is a diagram that illustrates a method of removing an audio speaker from a vehicle by using the device as illustrated in FIG. 13;

FIG. 15C is a diagram that illustrates a method of removing an audio speaker from a vehicle by using the device as illustrated in FIG. 13;

FIG. 16 is a sectional view of a device for mounting an audio speaker in a vehicle according to yet another embodiment of the present disclosure.

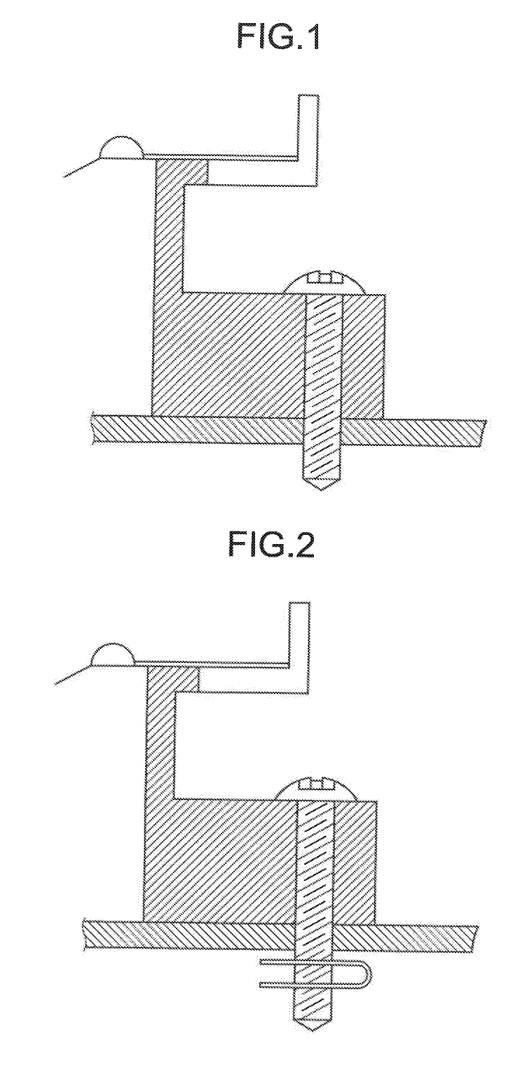

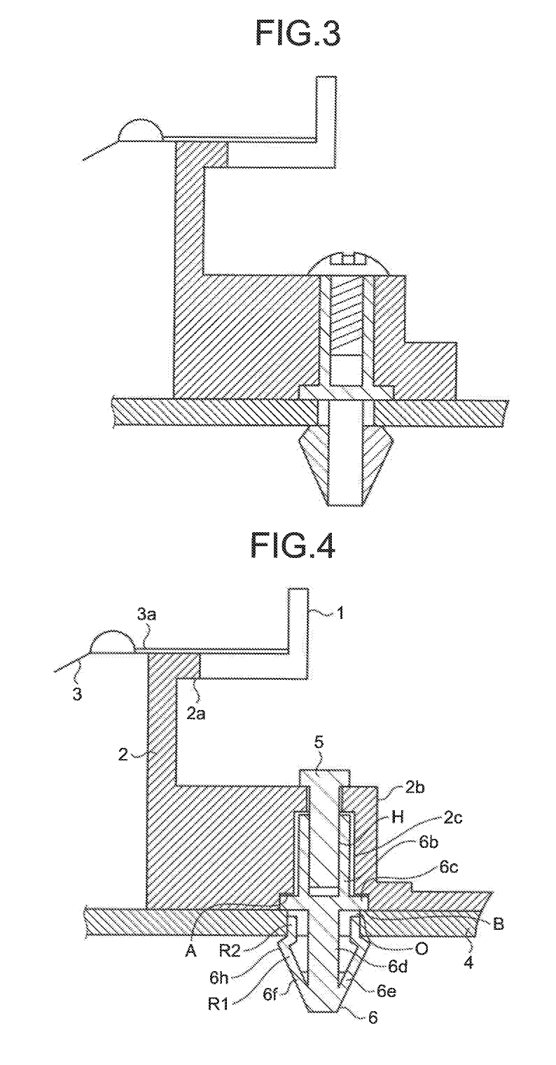

### DESCRIPTION OF EMBODIMENTS

While the disclosure is susceptible to various modifications and alternative forms or is subject to various modifications and alternative forms, a specific embodiment thereof has been illustrated by way of example in the figures and will be described in detail, below. It should be understood, however that it is not intended to limit the disclosure to the particular forms disclosed, but on the contrary, the invention is to cover all modifications, equivalents, and alternatives falling within the spirit and the scope of the invention as defined by the appended claims.

Before describing in detail embodiments or the various embodiments of the present disclosure it may be observed that the novelty and inventive step that are in accordance with the present disclosure reside in an improved device for mounting a speaker on a body panel of vehicle. It is to be noted that a person skilled in the art can be motivated from the present disclosure and can perform various modifications or modify various constructions of assembly, which are varying from vehicle to vehicle. However, such modification should be construed within the scope or the scope and spirit of the invention. Accordingly, the drawings are illustrating only those specific details that are pertinent to understanding the embodiments of the present disclosure so as not to obscure the disclosure with details that will be readily apparent to those of ordinary skill in the art having benefit of the description herein.

The terms “comprises”, “comprising”, or any other variations thereof , are intended to cover a non-exclusive inclusion, such that an assembly, a setup, a system, or a device that includes a list of components does not include only those components but may include other components not expressly listed or inherent to such system or setup or device. In other words, one or more elements in a system or apparatus or device proceeded by “comprises . . . a” does not, without more constraints, preclude existence of other elements or additional elements in an assembly or system or apparatus. The following paragraphs explain present disclosure. The disclosure in respect of the same may be deduced accordingly.

Accordingly the present disclosure relates to an improved device for mounting a sneaker onto a body panel of a vehicle including a clip and a pin and a mounting construction thereof. It is to be noted that a body panel of a vehicle includes a door structure, floor, roof and any other member in fixed or removable contact with a main frame of the vehicle.

With respect to mounting of an audio speaker to a body panel of a vehicle by means of an improved mounting device disclosed in the present disclosure, it is to be noted that an audio speaker can be mounted onto the body panel of a vehicle by means of a singular mounting device or by a plurality of such devices.

Accordingly, the present disclosure provides an improved mounting device for mounting an audio speaker having an mounting plate in a vehicle, the mounting device including:
an engaging plate;
a first engaging member disposed on a first side of engaging plate, the first engaging member having a longitudinal threaded groove; and
a second engaging member disposed on a second side of the engaging plate, the second engaging member having opposite locking ribs, the second engaging member having a channel.

In an embodiment of the present disclosure, the mounting device is secured with a speaker frame by means of the first engaging member through a screw being tightened in the threaded groove.

In another embodiment of the present disclosure, the second engaging member is adapted to pass through a fixing hole on the mounting plate of a vehicle body.

In yet another embodiment of the present disclosure, the locking ribs are adapted to elastically deform for passing through a fixing hole and be elastically restored.

In one more embodiment of the present disclosure, the channel is adapted to drain water intruding between a speaker body and the mounting plate away from the speaker body.

The following paragraphs describe the present disclosure with reference to FIGS. 4 to 16 according to an embodiment of the present description.

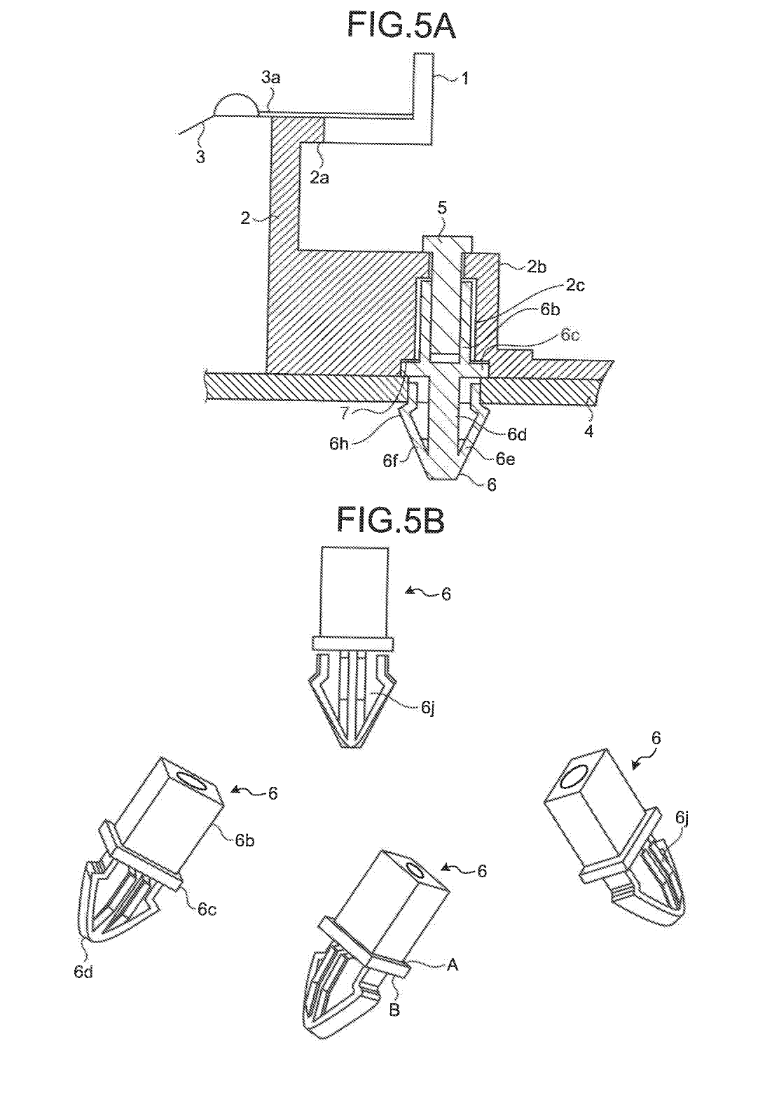

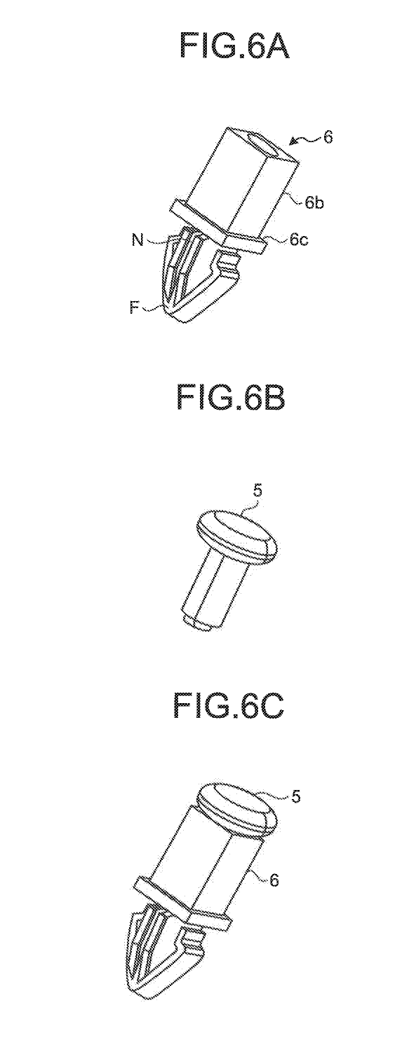

FIG. 4 depicts a sectional view of a device for mounting an audio speaker in a vehicle, including a clip and a screw and a mounting construction thereof in accordance with the present disclosure, wherein a cushion has not been used. FIG. 5A and FIG. 5B illustrate a sectional view of a device for mounting an audio speaker in a vehicle, including a clip and a screw and a mounting construction thereof in accordance with the present disclosure, wherein a cushion has been used. FIG. 6A, FIG. 6B, and FIG. 6C illustrate an isometric view of a device for mounting an audio speaker in a vehicle with respect to a clip and a screw according to an embodiment of the present disclosure.

As illustrated in FIG. 4, an audio speaker (1), generally conical shaped, includes a vibration plate (3) having a resilient edge at an upper end. The upper end of the vibration plate (3) is fixed circumferentially inside a frame (2). The frame is generally made of a plastic material. The frame (2) has an upper plate (2a) that is bonded by an adhesive material with a lower surface of a top plate (3a) of the vibration plate (3). A circumferential urethane cushion is also provided on an upper surface (2a) of the frame (2). The frame (2) has a lower plate (2b) which forms a square pocket (2c) for receiving a first engaging member (6b) of a mounting device (6). An mounting plate (4) having a plurality of fixing holes (O) is provided so as to mount an audio speaker to the frame by means of the mounting device (6). A diameter of the fixing holes (O) is such that it allows a second engaging member (6d) of the mounting device (6) during a mounting/unmounting operation.

The mounting device (6) is made of polymeric material such as Nylon (registered trademark) 6, Nylon (registered trademark) 66 etc. The mounting device includes an engaging plate (6c) of a generally rectangular shape. A shape and configuration of the engaging plate may however vary based on a factor such as a requirement of a user, shape or size of an audio speaker, etc. The engaging plate (6c) has a first side (A) and an opposite second side (B). As illustrated in FIG. 4, FIG. 5A, and FIG. 53, a rectangular parallelepiped first engaging member (6b) is disposed on the first side (A) of the engaging plate (6c). The first engaging member (6b) is formed longitudinally in an upward direction from the first side (A). The term “longitudinal” herein refers to a direction perpendicular to a plane of the engaging plate (6c). The first engaging member (6b) has a proximal end and a distal end. The first engaging member (6b) is being attached to the engaging plate (6c) at the proximal end. The first engaging member (6b) has an internal threaded groove (H) formed in a longitudinal direction and having a threaded opening at the distal end of the first engager. The threaded groove (H) is configured to receive a screw (5) as illustrated in FIG. 6A, FIG. 6B, and FIG. 6C.

Disposed oppositely on the second side (B) of the engaging plate (6c) is the second engaging member (6d). The second engaging member (6d) has a near end (N) and a far end (F), and extends longitudinally in a downward direction from the second side (B). The second engaging member (6d) is being attached to the engaging plate (6c) at the near end. A plurality of longitudinal locking ribs (6e, 6f) is disposed oppositely at the far end of the second engaging member (6d). The two locking ribs (6e, 6f), having a base region (R1) and a free end (R2), extend outwards upwardly having a generally flange like shape. The locking ribs (6e, 6f) are attached to the far end (F) of the second engaging member (6d) at the base region and extend upwardly from the far end of the second engaging member such that the free end is adjacent to the engaging plate (6c) thereby providing an “arrow-head” like shape to the second engaging member (6d). A general configuration of the locking ribs (6e, 6f) is such that a width of a flanged portion of the locking ribs near the free ends is slightly more than a diameter of a fixing hole (O) of the mounting plate (4). Provided at the free end of the locking ribs (6e, 6f) is a kink portion (6h).

For mounting an audio speaker onto a body of a vehicle, the second engaging member (6d) of the mounting device (6) is inserted in the fixing hole (O) of the mounting plate. The second engaging member (6d) of the mounting device (6) is adapted to pass through the fixing hole (O) such that the locking ribs (6e, 6f) deform elastically. On emerging from an opposite side of the fixing hole (O), the locking ribs restore to an original condition such that the kink potion (6h) of the locking ribs (6e, 6f) latches onto an inner periphery of the fixing hole (O) thereby securing the second engaging member (6d) with the mounting plate (4). In this condition of the mounting device (6), the second side (B) of the engaging plate (6c) abuts with the mounting plate (4), thereby restricting the mounting device (6) from passing entirely through the fixing hole (O). In this position, the first engaging member (6b) of the mounting device (6) is received in the square pocket (2c) of the lower plate (2b) of the frame (2). A threaded screw (5) is tightened in the threaded groove (H) of the first engaging member, thereby securing a speaker on the mounting plate (4) by means of the mounting device (6).

In another embodiment of the present disclosure, as illustrated in FIG. 5A, a cushion (7) made from urethane is provided between an upper side of the engaging plate (6c) and a corresponding mating lower side of the lower plate (2b).

As depicted in FIG. 5B, the second engaging member (6d) has two parallel protrusions extending longitudinally from the engaging plate (6c) to the far end (F) of the second engaging member (6d), thereby forming a channel (6′). As illustrated in a side view, the channel (6j) is located at right angles to the opposite locking ribs (6e, 6f). The channel (6j) of the second engaging member (6d) prevents water from accumulating in a region of the mounting device (6) by draining away water from the engaging plate (6c). Thus, it is possible to drain water through a surface of the second engaging member (6d) due to the channel (6j) provided on the surface of the second engaging member (6d), Hence, it is possible to prevent corrosion of a metal screw mounted in the threaded groove (H) of the first engaging member (6b), As a result, it is possible to improve durability of the mounting device (6).

Additionally, although the first engaging member (6b) of the mounting device (6) has the threaded groove (H), a thread of the first engaging member (6b) may be formed by tightening a self-tapping screw to the non-threaded first engaging member (6b) at a time of mounting by the mounting device (6).

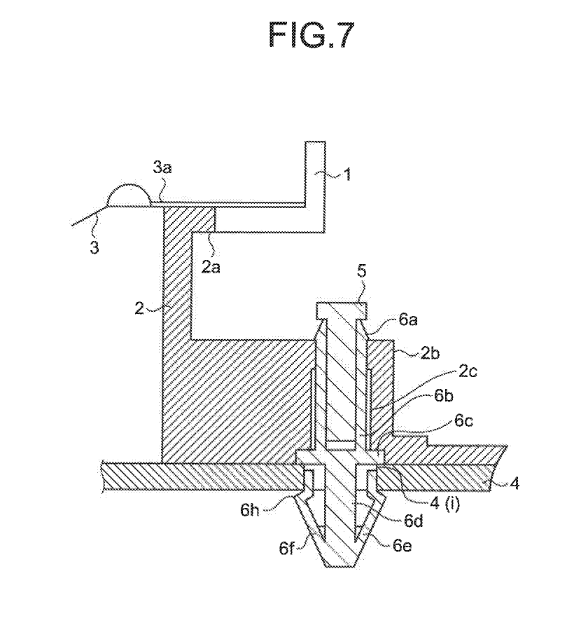

FIG. 7 illustrates a sectional view of a device for mounting an audio speaker in a vehicle, including a clip and a pin and a mounting construction thereof in accordance with an embodiment of the present disclosure, wherein a cushion has not been used.

As illustrated in FIG. 7, the speaker (1) has a vibration plate (3) in a cone form having a resilient edge at an upper end which is fixed inside a plastic frame having a circumferential shape. A frame (2) has an upper plate (2a). The upper plate (2a) is bonded by an adhesive with a lower surface of a top plate (3a) of the vibration plate (3), A circumferential urethane cushion is also provided on an upper surface (2a) of the frame (2). The frame (2) has a lower plate (2b) which forms a square pocket (2c) for receiving an upper portion of a mounting clip (6).

A body panel (4) of a vehicle is a mounting plate that has a plurality of fixing holes. The body panel (4) is provided so as to mount an audio speaker to a frame thereof by means of the mounting clip (6). A diameter of the fixing holes is such that it allows mounting/removing of a second engager (6d) of the mounting clip (6) during a mounting/removing operation.

The mounting clip (6) is formed of a plastics resin such as PET or Nylon (registered trademark) and has an engaging plate (6c) at some predefined distance from ends of the clip. An engaging plate (6c) has a generally rectangular shape. However, a shape and configuration of the engaging plate (6c) may vary based on a factor such as a requirement of a user, a shape or size of an audio speaker, etc. The engaging plate (6c) has a first side and a second side that is opposite to the first side.

Extending upwards in a longitudinal direction from this engaging plate (6c) is a cylindrical piped first engager (6b). A first engager (6b) that is a cylindrical pipe is disposed on the first side of the engaging plate (6c). The first engager (6b) is formed longitudinally in an upward direction from the first side. Herein, the term “longitudinal” refers to a direction perpendicular to a plane of the engaging plate (6c). The first engager (6b) has a proximal end and a distal end. The first engager (6b) is attached to the engaging plate (6c) at the proximal end. The first engager (6b) has triangular vertical taper locks (6a) at the distal end of the first engager. The first engager (6b) splits into three sections towards its upper region and three corresponding triangle vertical taper locks (6a) are formed at a top end of the first engager (6b). The taper locks (6a) are formed on the first engager (6b) so that they protrude outwards at a base from a line of an outer surface of the cylindrical first engager (6b).

Extending longitudinally downwards from the engaging plate (6c) is a second engager (6d). The second engager (6d) is oppositely disposed on the second side of the engaging plate (6c). The second engager. (6d) has a near end (N) and a far end (F) and extends longitudinally in a downward direction from the second side. The second engager (6d) is attached to the engaging plate (6c) at the near end. The second engager has an arrow head shape and is made to fit into a body panel of a vehicle. Slant locks (6e and 6f) are attached to the far end (F) of the second engager (6d) in a base region and extend upwardly from the far end of the second engager in such a manner that a free end is adjacent to the engaging plate (6c), so that the second engager (6d) is provided with an “arrow-head”-like shape. Two slant locks (6e and 6f) are displaced on opposite sides of the second engager (6d). The plurality of longitudinal slant locks (6e and 6f) is oppositely disposed at the far end of the second engager (6d). The slant locks (6e and 6f) are formed at a lower end of the second engager (6d) and extend upwards towards the engaging plate (6c) , The slant locks extend outwards from a vertical axis towards the engaging plate (6c). The two slant locks (6e, 6f) that have a base region and a free end extend outwardly and upwardly so as to have a generally flange-like shape. A general configuration of the slant locks (6e, 6f) is such that a width of a flange-like portion of the slant locks near the free end is slightly greater than a diameter of the fixing hole of the body panel (4). Provided at the free end of the slant locks (6e, 6f) is a kink portion (6h). Kinks (6h) are provided on slant locks (6e and 6f) for a purpose of latching onto a body panel of a vehicle.

The first engager (6b) is configured to have a concave portion that receives a pin (5). A cylindrical pin (5) adapted to mate with a corresponding hollow internal section of the first engager (6b) is provided to secure the clip (6) against elastic deformation. The pin (5) is a T shaped solid structure with a shaft inserted in a downward direction in the first engager (6b).

As illustrated in FIG. 7, in order to mount the clip (6) on the frame (2) of the audio speaker, the first engager (6b) and engaging plate (6c) of the clip (6) are inserted into a mounting hole provided on the lower plate (2b) of the frame (2). The first side of the engaging plate (6c) of the clip (6) engages with or contacts a surface of a concave portion that composes the mounting hole on a lower side of the lower plate (2b) of the frame (2), so that the clip (6) is restricted from completely passing through the mounting hole. The first engager (6b) of the clip (6) is received in the square pocket (2c) formed on the lower plate (2b) of the frame (2). When the taper locks (6a) formed on the first engager (6b) of the clip (6) pass through an inner peripheral surface that composes the mounting hole on an upper side of the lower plate (2b) of the frame (2), the taper locks (6a) are elastically deformed. When the taper locks (6a) emerge from the mounting hole on an upper side of the lower plate (2b) of the frame (2), the taper locks (6a) are restored to an original state thereof and engage with a surface of the lower plate (2b) on the upper side of the lower plate (2b) of the frame (2). Thus, the clip (6) is fixed on the lower plate (2b) of the frame (2) of the speaker by the first engager (6b) and engaging plate (6c) of the clip (6). As a result, the clip (6) is mounted on the frame (2) of the speaker.

A concave portion that receives and holds a shaft of the pin (5) (that is not a screw) is provided at a center of the cylindrical first engager (6b) of the clip (6). The shaft of the pin (5) is inserted or pressed into the concave portion provided at the center of the first engager (6b) of the clip (6). The shaft of the pin (5) engages with an inner peripheral surface of the concave portion provided at the center of the first engager (6b) to press the taper locks (6a) formed on the first engager (6b) apart outwardly. The taper locks (6a) formed on the first engager (6b) are fixed by the shaft of the pin (5). Thus, the taper locks (6a) are deformed toward the center of the first engager (6b), so that it is possible to prevent the taper locks (6a) from separating from a surface of the lower plate (2b) of the frame (2). As a result, it is possible to prevent the clip (6) from separating from the frame (2).

As illustrated in FIG. 7, in order to mount the clip (6) on the body panel (4) of the vehicle, the second engager (6d) of the clip (6) is inserted into a fixing hole (4(i)) provided on the body panel (4) of the vehicle. When the slant locks (6e and 6f) formed on the lower end of the second engager (6d) of the clip (6) pass through an inner peripheral surface that composes the fixing hole (4(i)) provided on the body panel (4), the slant locks (6e and 6f) are elastically deformed. When the slant locks (Ge and 6f) emerge from the fixing hole (4(i)) of the body panel (4), the slant locks (6e and 6f) are restored to an original state thereof. Herein, the kinks (6h) of the slant locks (6e and 6f) engage with a lower surface of the body panel (4) and portions upper than the kinks (6h) of the slant locks (6e and 6f) engage with the inner peripheral surface that composes the fixing hole (4(i)) of the body panel (4). Furthermore, the second side of the engaging plate (6c) of the clip (6) engages with or contacts an upper surface of the body panel (4), so that the clip (6) is restricted from completely passing through the fixing hole (4(i)). Thus, the clip (6) is fixed on the body panel (4) of the vehicle by the engaging plate (6c) and second engager (6d) of the clip (6). As a result, the clip (6) is mounted on the body panel (4) of the vehicle.

Thus, the speaker is mounted on the body panel (4) of the vehicle by means of the clip (6) and the pin (5).

The clip (6) has the taper locks (6a) formed on the first engager (6b), so that a screw does not have to be mounted on/removed from the clip (6). Hence, a tool for mounting/removing of a screw for the clip (6) does not have to be used. It is possible to readily execute mounting/removing of the clip (6) for the frame (2) of the speaker by using the taper locks (6a) formed on the first engager (6b). Furthermore, a screw does not have to be mounted on the clip (6), so that it is possible to reduce a weight of the speaker mounted with the clip (6).

The device for mounting an audio speaker in a vehicle includes the pin (5) that has the shaft and the clip (6) that has the concave portion that receives the shaft of the pin (5), so that a screw does not have to be mounted on/removed from the clip (6). Hence, a tool for mounting/removing of a screw for the clip (6) does not have to be used. It is possible to readily prevent/allow elastic deformation of the taper locks (6a) formed on the first engager (6b) by using the pin (5) that has the shaft and the clip (6) that has the concave portion that receives the shaft of the pin (5). As a result, it is possible to readily execute mounting and holding/releasing and removing of the clip (6) for the frame (2) of the speaker. Furthermore, a screw does not have to be mounted on the clip (6), so that it is possible to reduce a weight of the speaker mounted with the clip (6).

The clip (6) has the slant locks (6e and 6f) that have the free end formed on the second engager (6d), so that it is possible to readily insert the slant locks (6e and 6f) that have the free end into the fixing hole (4(i)) of the body panel (4). Hence, it is possible to readily execute mounting/removing of the clip (6) for the frame (2) of the speaker by using the slant locks (6e and 6f) formed on the second engager (6d).

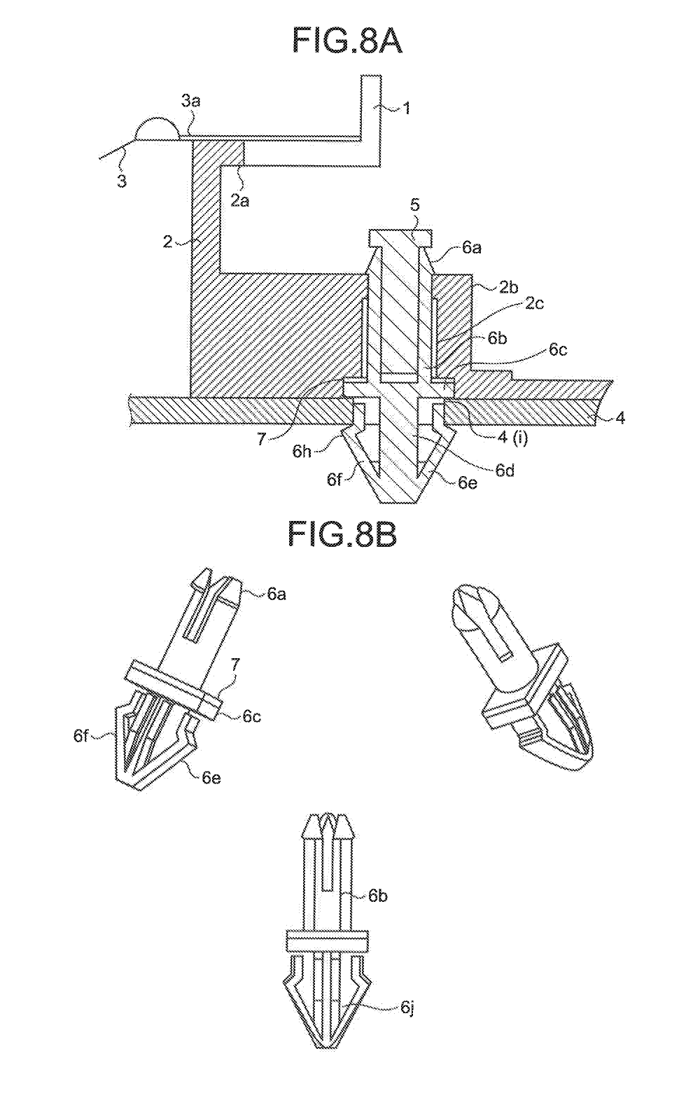

FIG. 8A and FIG. 8B illustrate a sectional view of a device for mounting an audio speaker in a vehicle, including a clip and a pin and a mounting construction thereof in accordance with an embodiment of the present disclosure, wherein a cushion has been used. The device as illustrated in FIG. 8A and FIG. 8B is different from the device as illustrated in FIG. 7 in that a clip (6) has a cushion (7) and a slot (6j).

In another embodiment of the current disclosure, as illustrated in FIG. 8A, a cushion (7) formed of urethane is provided between an upper side of the engaging plate (6c) and a corresponding mating lower side of the lower plate (2b). As depicted in FIG. 8B, the second engager (6d) has two parallel vertical plates protruding outwards from a center and they are disposed at 90 degrees from the slant locks (6e and 6f). The plates have a central drain like slot (6j) for preventing water from intruding into the construction. Two slots (6j) are provided on opposite sides of the lower engager (6d) of the clip (6).

As illustrated in FIG. 8A and FIG. 8B, the clip (6) has the cushion (7) provided on the engaging plate (6c). When the clip (6) is mounted on a frame (2) of a speaker, the cushion (7) that is made of urethane is disposed between a first side of the engaging plate (6c) and a surface of a concave portion that composes a mounting hole on the lower side of the lower plate (2b) of the frame (2). The clip (6) has the cushion (7), so that it is possible to stabilize the clip (6) mounted on the frame (2) of the speaker.

As illustrated in FIG. 8B, the second engager (6d) of the clip (6) has two parallel protrusions that longitudinally extend from the engaging plate (6c) to a far end of the second engager (6d), so that a slot (6j) is formed. The slot (6j) is provided on a side of the second engager (6d). That is, the slot (6j) is located at a right angle to the opposite slant locks (6e, 6f). The slot (6j) provided on the second engager (6d) is useful for positioning of the clip (6) on the frame (2) of the speaker and reinforcement of the second engager (6d) of the clip (6). Furthermore, the slot (6j) provided on the second engager (6d) drains, from the engaging plate (6c), water that intrudes between the frame (2) of the speaker and a body panel (4) of a vehicle, so that water is prevented from accumulating in a region of the clip (6). Thus, it is possible to drain water through a surface of the second engager (6d) due to the slot (6j) provided on the surface of the second engager (6d).

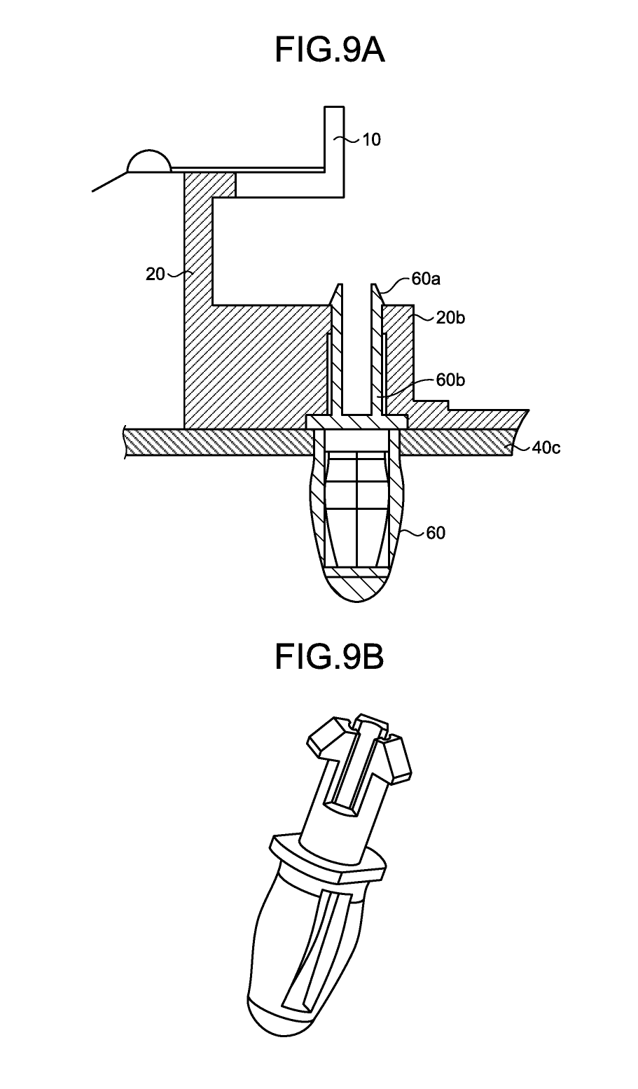

FIG. 9A and FIG. 9B illustrate an isometric view of the device for mounting audio speaker in vehicle, in accordance with an embodiment of the present disclosure. The device as illustrated in FIG. 9A and FIG. 9B is different from the device as illustrated in FIG. 7 in that a clip (6) has a fixture (60) instead of the second engager (6d) and a pin (5) is not inserted into the clip (6).

In yet another embodiment of the present invention, as illustrated in FIGS. 9A and 9B, a similar mounting device including a fixture (60) is provided wherein an upper portion (60b) of the fixture (60) has a plurality of triangular locks (60a) formed to butt with a lower plate (20b).

The device as illustrated in FIG. 9A and FIG. 9B has the fixture (60) that is different from the second engager (6d) of the clip (6) in the device as illustrated in FIG. 7. A portion of the fixture (60) near a center thereof in a longitudinal direction is slightly greater than a diameter of a fixing hole provided on a body panel (40c) but can elastically deform due to a space provided near the center of the fixture (60). In order to mount an audio speaker on the body panel (40c) of a vehicle, the fixture (60) as a clip is inserted into the fixing hole provided on the body panel (40c). When the fixture (60) as a clip passes through the fixing hole, the portion of the fixture (60) near the center thereof in a longitudinal direction is elastically deformed. When the fixture (60) as a clip emerges from an opposite side of the fixing hole, the portion of the fixture (60) near the center thereof in a longitudinal direction is restored to an original state thereof, so that the portion of the fixture (60) near the center thereof in a longitudinal direction engages with a surface of the body panel (40c). Thus, the clip is mounted on the body panel (40c).

Although the pin (5) as illustrated in FIG. 7 is not inserted into the clip as illustrated in FIG. 9A and FIG. 9B, the plurality of triangular locks (60a) provided on the upper portion (60b) of the clip engage with a surface of the lower plate (20b) of a frame (20) of a speaker (10). Thereby, the clip is mounted on the frame (20) of the speaker.

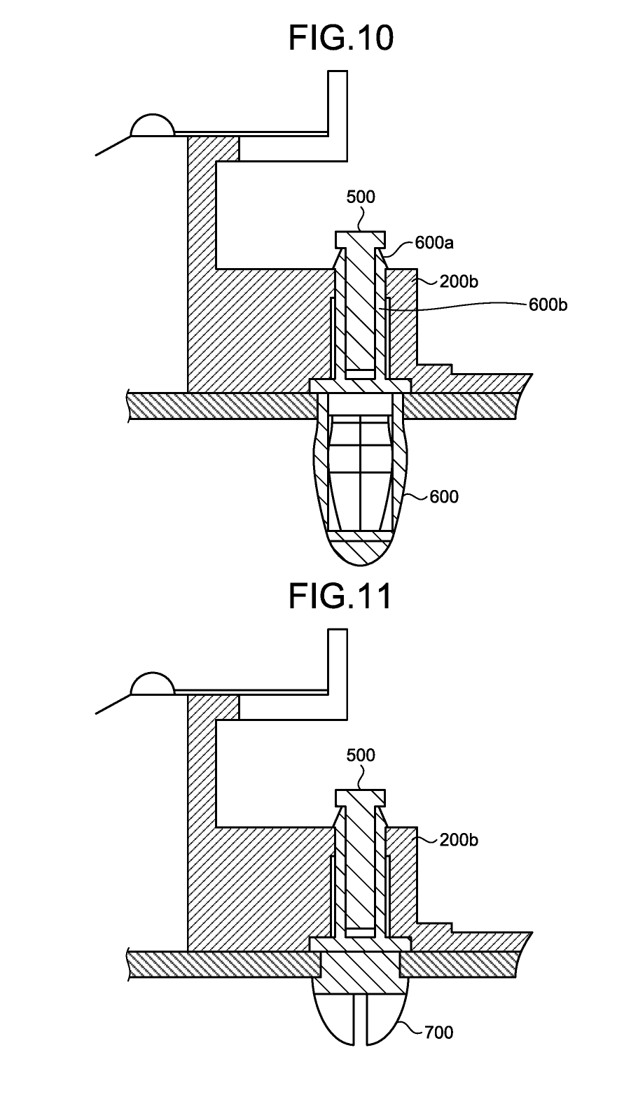

FIG. 10 illustrates a sectional view of a device for mounting an audio speaker in a vehicle, in accordance with another embodiment of the present disclosure. The device as illustrated in FIG. 10 is different from the device as illustrated in FIG. 9A and FIG. 9B in that a pin (500) is inserted into a concave portion provided at a center of a clip.

In yet another embodiment of the present invention, as illustrated in FIG. 10, a similar mounting device including a fixture (600) and a pin (500) is provided wherein an upper portion (600b) of the fixture (600) has a plurality of triangular locks (600a) formed to butt with a lower plate (200b) and a T shaped pin adapted to be inserted in a blind hole on an inner side of the locks (600a).

As illustrated in FIG. 10, the pin (500) is inserted into the concave portion provided on the hollow upper portion (600b) of the clip, so that it is possible to prevent the plurality of triangular locks (600a) from releasing from a surface of the lower plate (200b) of a frame due to deformation of the plurality of triangular locks (600a). Thus, it is possible to prevent the clip from separating from the frame.

FIG. 11 illustrates a sectional view of a device for mounting an audio speaker in a vehicle, in accordance with other embodiments of the present disclosure. The device as illustrated in FIG. 11 is different from the device as illustrated in FIG. 7 in that a clip (6) has a fixture (700) instead of the second engager (6d).

In one another embodiment of the present disclosure, as illustrated in FIG. 11, a similar mounting device as disclosed in the above embodiment is provided wherein a fixture (700) has a different shape.

The device as illustrated in FIG. 11 has the fixture (700) that is different from the second engager (6d) of the clip (6) in the device as illustrated in FIG. 7. A portion of the fixture (700) near a center thereof in a longitudinal direction is slightly greater than a diameter of a fixing hole provided on a body panel, but can elastically deform due to a space provided near a tip of the fixture (700). In order to mount an audio speaker on the body panel of a vehicle, the fixture (700) as a clip is inserted into a fixing hole provided on the body panel. When the fixture (700) as a clip passes through the fixing hole, a portion of the fixture (700) from a vicinity of the center to the tip thereof in a longitudinal direction is elastically deformed. When the fixture (700) as a clip emerges from an opposite side of the fixing hole, the portion of the fixture (700) from a vicinity of the center to the tip thereof in a longitudinal direction is restored to an original state thereof, so that the portion of the fixture (700) near the center thereof in a longitudinal direction engages with a surface of the body panel. Thus, the clip is mounted on the body panel.

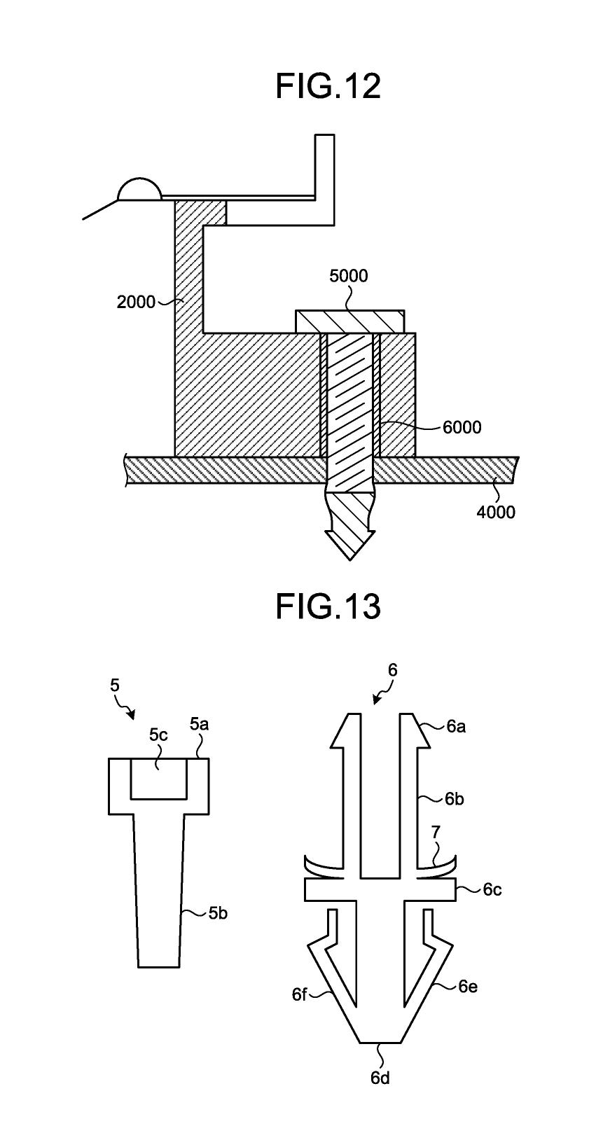

FIG. 12 illustrates a sectional view of a device for mounting an audio speaker in a vehicle, in accordance with yet another embodiment of the present invention.

In still one other embodiment of the present disclosure, as illustrated in FIG. 12, a plastic threaded bolt (5000) is fitted with a frame (2000) having a threaded insert (6000). The threaded bolt (5000) is received in the threaded insert (6000) in a downward direction to facilitate rigid contact.

As illustrated in FIG. 12, the threaded bolt (5000) is fitted in the threaded insert (6000) provided on the frame (2000) of a speaker, so that the threaded bolt (5000) can be mounted on the frame (2000). A portion of the threaded bolt (5000) near a tip thereof in a longitudinal direction is slightly greater than a diameter of a fixing hole provided on a body panel (4000) but can elastically deform. In order to mount an audio speaker on the body panel of a vehicle, the threaded bolt (5000) is inserted into the fixing hole provided on the body panel (4000). When the threaded bolt (5000) passes through the fixing hole, the portion of the threaded bolt (5000) near a tip thereof in a longitudinal direction is elastically deformed. When the tip of the threaded bolt (5000) emerges from an opposite side of the fixing hole, the portion of the threaded bolt (5000) near a tip thereof in a longitudinal direction is restored to an original state thereof, so that the portion of the threaded bolt (5000) near a tip thereof in a longitudinal direction engages with a surface of the body panel. Thus, as a result of being able to mount the threaded bolt (5000) on the body panel, the frame (2000) of the speaker can be mounted on the body panel (4000) by using the threaded bolt (5000).

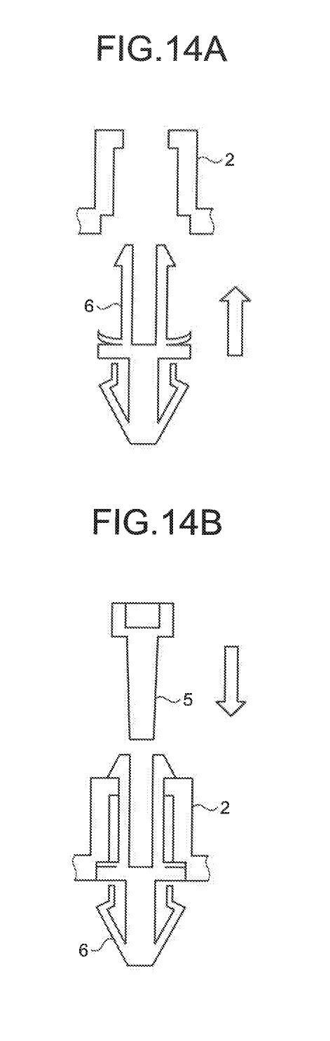

FIG. 13 is a sectional view of a device for mounting an audio speaker in a vehicle according to yet another embodiment of the present disclosure. The device as illustrated in FIG. 13 is different from the device as illustrated in FIG. 8A and FIG. 8B in that a pin (5) has a tapered shaft (5b) and a head portion (5a) provided with a concave portion (5c) and a clip (6) has a different cushion (7).

The device as illustrated in FIG. 13 includes the pin (5) and the clip (6). The pin (5) is formed of a rubber while the clip (6) is formed of a plastic resin.

The pin (5) as illustrated in FIG. 13 has the integrally formed head portion (5a) and shaft (5b), similarly to the pin (5) as illustrated in FIG. 8A. The shaft (5b) of the pin (5) is tapered so as to taper toward an opposite side of the head portion (5a) of the pin (5). A diameter of a cross section of the shaft (5b) of the pin (5) in a direction perpendicular to a longitudinal direction increases toward the head portion (5a) of the pin (5), and includes a diameter that is greater than a diameter of a cross section of a concave portion provided at a center of a cylindrical first engager (6b) of the clip (6) in a direction perpendicular to a longitudinal direction.

Hence, as the shaft (5b) of the pin (5) is inserted or pressed into the concave portion provided at the center of the first engager (6b), it is possible to press the taper locks (6a) provided on the first engager (6b) against a surface of a frame of a speaker. Thus, the pin (5) that has the tapered shaft (5b) is inserted or pressed into the concave portion provided at the center of the first engager (6b), so that it is possible to readily hold engagement of the taper locks (6a) provided on the first engager (6b) with a surface of the frame of the speaker.

On the other hand, as the shaft (5b) of the pin (5) is pulled from the concave portion provided at the center of the first engager (6b), it is possible to release a pressure of the taper locks (6a) provided on the first engager (6b) against a surface of the frame of the speaker. Thus, the pin (5) that has the tapered shaft (5b) is pulled from the concave portion provided at the center of the first engager (6b), so that it is possible to readily release engagement of the taper locks (6a) provided on the first engager (6b) with a surface of the frame of the speaker.

The head portion (5a) of the pin (5) has the concave portion capable of elastically deforming the taper locks (6a) by putting the taper locks (6a) provided on the first engager (6b) of the clip (6) therein. A diameter of a cross section of the concave portion provided on the head portion (5a) of the pin (5) in a direction perpendicular to a longitudinal direction is less than or equal to a diameter of a mounting hole provided on the lower plate (2b) of the frame (2) of the speaker at a side of the taper locks (6a). In such a case, as the taper locks (6a) are put in the concave portion provided on the head portion (5a) of the pin (5), it is possible to elastically deform the first engager (6b) in such a manner that the taper locks (6a) are located in a region with a diameter less than a diameter of the mounting hole.

It is possible to readily release engagement of the taper locks (6a) with a surface of the frame of the speaker by using the pin (5) that has the head portion (5a) provided with such a concave portion. Thus, it is possible to use the pin (5) that has the head portion (5a) provided with the concave portion as a tool of removing of the clip (6) from a surface of the frame of the speaker. As result, it is possible to readily remove the clip (6) from a surface of the frame of the speaker by using the pin (5) that has the head portion (5a) provided with the concave portion.

The clip (6) as illustrated in FIG. 13 has the integrally formed taper locks (6a), first engager (6b), engaging plate (6c), second engager (6d), slant locks (6e and 6f), cushion (7), and non-illustrated slot (6j) (see FIG. 8B), similarly to the clip (6) as illustrated in FIG. 8A and FIG. 8B. The first engager (6b) and second engager (6d) of the clip (6) function as a snap-fit. The cushion (7) of the clip (6) is formed on the engaging plate (6c) integrally with other portions of the clip (6). The cushion (7) has tip portions formed so as to separate outwardly from the first engager (6b) and upwardly from the engaging plate (6c). When the tip portions of the cushion (7) are pressed against the engaging plate (6c), the tip portions of the cushion (7) are elastically deformed toward the engaging plate (6c).

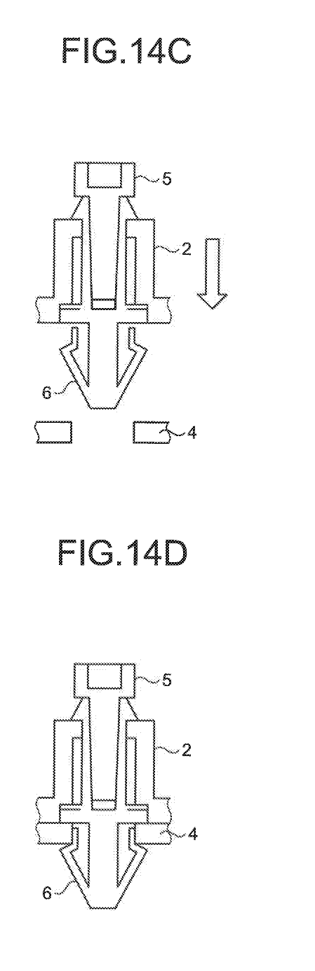

FIG. 14A, FIG. 14B, FIG. 14C, and FIG. 14D are diagrams that illustrate a method of mounting an audio speaker in a vehicle by using the device as illustrated in FIG. 13.

First, as illustrated in FIG. 14, the clip (6) is inserted into a mounting hole provided on a frame (2) of a speaker. As illustrated in FIG. 14B, the taper locks (6a) formed on the first engager (6b) of the clip (6) engage with an upper surface of a lower plate (2b) of the frame (2) of the speaker. Thus, it is possible to readily execute mounting of the clip (6) on the upper surface of the frame (2) of the speaker by using the taper locks (6a) formed on the first engager (6b). The engaging plate (6c) and cushion (7) of the clip (6) engage with a surface of a concave portion that composes the mounting hole on a lower side of the lower plate (2b) of the frame (2) of the speaker.

The cushion (7) of the clip is disposed between the engaging plate (6c) of the clip (6) and the lower plate (2b) of the frame (2) of the speaker, and a tip portion of the cushion (7) is elastically deformed toward the engaging plate (6c). Herein, engagement of the taper locks (6a) of the first engager (6b) with the upper surface of the lower plate (2b) of the frame (2) of the speaker is improved by restoring force of the cushion (7) of the clip (6). Thereby, it is possible to stabilize mounting of the clip (6) on the frame (2) of the speaker.

Then, as illustrated in FIG. 14B, the shaft (5b) of the pin (5) is inserted or pressed into a concave portion provided at a center of the first engager (6b) of the clip (6). Thereby, the taper locks (6a) formed on the first engager (6b) of the clip (6) are outwardly pressed apart by the shaft (5b) of the pin (5). The taper locks (6a) of the first engager (6b) are fixed by the shaft (5b) of the pin (5). Thus, it is possible to readily hold engagement of the taper locks (6a) of the first engager (6b) with the upper surface of the lower plate (2b) of the frame (2) of the speaker by inserting or pressing the pin (5) into the concave portion provided on the first engager (6b) of the clip (6).

The shaft (5b) of the rein (5) is tapered, so that it is possible to readily insert the shaft (5b) of the pin (5) into the concave portion provided at the center of the first engager (6b) of the clip (6). Furthermore, it is possible to readily fix the pin (5) on the first engager (6b) of the clip (6).

The pin (5) is formed of a rubber, so that the pin (5) is held on the first engager (6b) of the clip due to restoring force against deformation of the rubber and friction force of the rubber on an inner peripheral surface of the concave portion provided at the center of the first engager (6b). Thereby, it is possible to readily hold the pin (5) on the first engager (6b) of the clip (6).

Thus, it is possible to mount the clip (6) on the frame (2) of the speaker by using the pin (5).

Then, as illustrated in FIG. 14C, the second engager (6d) of the clip (6) mounted on the frame (2) of the speaker is inserted into a fixing hole provided on a body panel (4) of a vehicle. As illustrated in FIG. 14D, the slant locks (6e and 6f) formed on the second engager (6d) of the clip (6) engage with a surface of the body panel (4) and an inner peripheral surface of the fixing hole thereof. The slant locks (6e and 6f) formed on the second engager (6d) have shapes capable of being readily elastically deformed, so that it is possible to readily insert the second engager (6d) of the clip (6) into the fixing hole provided on the body panel (4) of the vehicle. Thus, it is possible to mount, on the body panel (4), the clip (6) mounted on the frame (2) of the speaker.

Therefore, it is possible to mount the frame (2) of the speaker on the body panel (4) of the vehicle by using the pin (5) and the clip (6).

Thus, the pin (5) and the clip (6) are used without using a screw, so that it is possible to readily and quickly mount the clip (6) on the frame (2) of the speaker without using another tool such as a screwdriver for fixing a screw.

Furthermore, the clip (6) is mounted on the f (2) of the speaker by using the pin (5) without using a screw, so that it is possible to reduce a weight of the speaker mounted with the pin (5) and the clip (6).

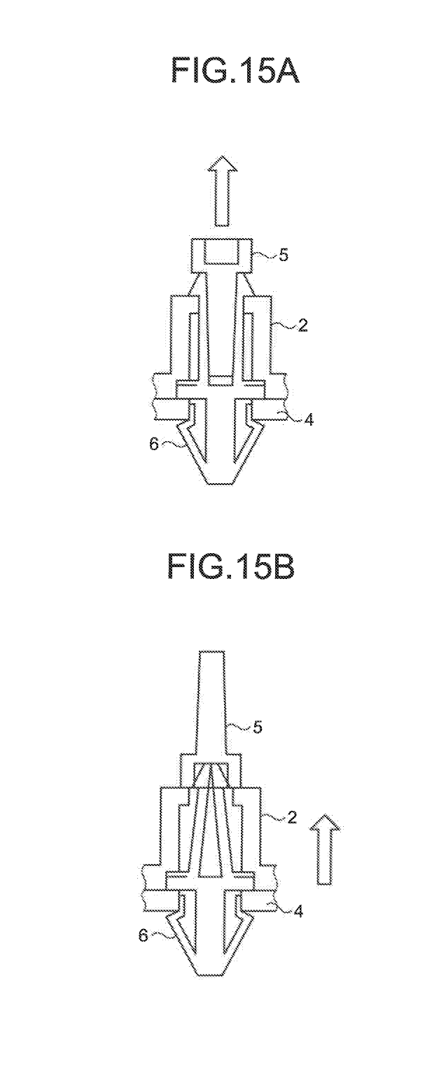

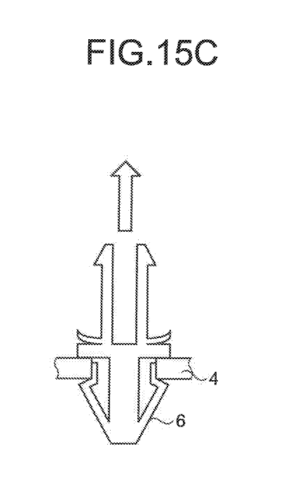

FIG. 15A, FIG. 15B, FIG. 15C, and FIG. 15D are diagrams that illustrate a method of removing an audio speaker from a vehicle by using the device as illustrated in FIG. 13.

First, as illustrated in FIG. 15A, the pin (5) is pulled from a concave portion provided at a center of the first engager (6b) of the clip (6). The shaft (5b) of the pin (5) is tapered, so that it is possible to readily pull the shaft (5b) of the pin (5) from the concave portion provided at the center of the first engager (6b) of the clip (6).

Then, as illustrated in FIG. 15B, the concave portion provided on the head portion (5a) of the pin (5) is pressed against the taper locks (6a) formed on the first engager (6b) of the clip (6). The taper locks (6a) formed on the first engager (6b) of the clip (6) are put in the concave portion (5c) provided on the head portion (5a) of the pin (5). Thereby, the first engager (6b) elastically deforms toward the center of the first engager (6b) and the taper locks (6a) are displaced toward the center of the first engager (6b). Thus, it is possible to readily release engagement of the taper locks (6a) of the first engager (6b) with a surface of a frame (2) of a speaker.

Then, as illustrated in FIG. 15B, the first engager (6b) of the clip (6) mounted on a body panel (4) is pulled from the frame (2) of the speaker in a state where the concave portion provided on the head portion (5a) of the pin (5) is pressed against the taper locks (6a) of the clip (6). Thus, it is possible to readily remove the clip (6) mounted on the body panel (4) from the frame (2) of the speaker by using the pin (5). That is, it is possible to remove the frame (2) of the speaker from the body panel (4). Furthermore, restoring force of the elastically deformed cushion (7) of the clip (6) facilitates removing of the clip (6) from a lower plate (2b) of the frame (2) of the speaker.

Then, as illustrated in FIG. 15C, the slant locks (6e and 6f) formed on the second engager (6d) of the clip (6) are elastically deformed toward a center of the second engager (6d) by a hand. Thereby, it is possible to release engagement of the slant locks (6e and 6f) of the second engager (6d) with a surface of the body panel (4) and an inner peripheral surface that composes a mounting hole thereof. The second engager (6d) of the clip (6) is pulled from the body panel (4) in a state where the slant locks (6e and 6f) of the second engager (6d) are elastically deformed toward the center of the second engager (6d). Thus, it is possible to remove the clip (6) from the body panel (4).

Therefore, it is possible to remove the frame (2) of the speaker from the body panel (4) of a vehicle by using the pin (5) and the clip (6).

Thus, engagement of the taper locks (6a) of the first engager (6b) with a surface of the frame (2) of the speaker is released without using a screw, so that it is possible to readily remove the clip (6) from the frame (2) of the speaker without using another tool such as a screwdriver for removing a screw.

Furthermore, the shaft (5b) of the pin (5) is pulled from the concave portion provided at the center of the first engager (6b) of the clip (6), so that it is possible to readily remove the clip (6) from the frame (2) of the speaker.

Furthermore, the pin (5) that has the head portion (5a) provided with the concave portion (5c) is used as a tool for removing the clip (6) from the frame (2) of the speaker, so that it is possible to readily and quickly remove the frame (2) of the speaker from the clip (6) without using another tool.

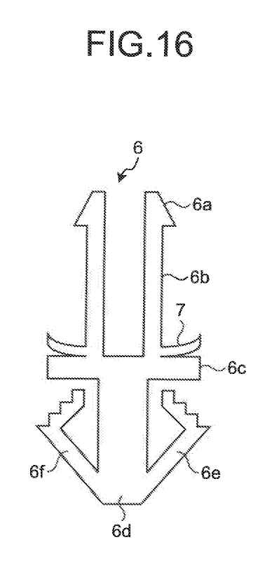

FIG. 16 is a sectional view of a device for mounting an audio speaker in a vehicle according to yet another embodiment of the present disclosure. The device as illustrated in FIG. 16 is different from the device as illustrated in FIG. 13 in that slant locks (6e and 6f) of a clip (6) has a different shape. Additionally, a pin (5) that is included in the device as illustrated in FIG. 16 is similar to the pin (5) that is included in the device as illustrated in FIG. 13, and hence, is not illustrated in FIG. 16.

Portions that extend from tip portions of slant locks (6e and 6f) formed on a second engager (6d) of the clip (6) as illustrated in FIG. 16, namely, kinks (6h) of the slant locks (6e and 6f) (see FIG. 7) to an engaging plate (6c) have a stepwise shape.

In a case where the clip (6) that has the slant locks (6e and 6f) with a stepwise tip portion is used, it is possible to engage the slant locks (6e and 6f) with a surface of a body panel (4) that has a different thickness and an inner peripheral surface that composes a fixing hole thereof. As a result, it is possible to mount a frame (2) of a speaker on the body panel (4) that has a different thickness.

Additionally, although the shaft (5b) of the pin (5) is tapered in the embodiment as described above, the inner peripheral surface that composes the concave portion provided at the center of the first engager (6b) may be tapered so as to taper toward the taper locks (6a) instead of the shaft (5b) of the pin (5) being tapered.

Furthermore, although a cross section of the concave portion provided on the head portion (5a) of the pin (5) in a direction perpendicular to a longitudinal direction has a generally circular shape in the embodiment as described above, the inner peripheral surface that composes the concave portion provided on the head portion (5a) of the pin (5) may be tapered so as to taper toward a side of the shaft (5b) of the pin (5). In such a case, it is possible to facilitate displacing the taper locks (6a) of the first engager (6b) toward the center of the first engager (6b). Herein, a taper angle of a taper applied to the inner peripheral surface that composes the concave portion provided on the head portion (5a) of the pin (5) is less than a taper angle of the taper locks (6a) provided on the first engager (6b) of the clip (6). In such a case, when the taper locks (6a) are put in the concave portion provided on the head portion (5a) of the pin (5), it is possible to elastically deform the first engager (6b) provided with the taper locks (6a).

Furthermore, although the pin (5) and the clip (6) are described as a device for mounting an audio speaker in a vehicle in the embodiment as described above, application of the clip (6) or the pin (5) and the clip (6) is not particularly limited and the clip (6) or the pin (5) and the clip (6) can be used in a product that needs mounting and removing of a member.

With respect to use of substantially any plural and/or singular terms herein, those having skill in the art can translate from the plural to the singular and/or from the singular to the plural as is appropriate to context and/or application. Various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “having” should be interpreted as “having at least,” etc.). It will be further understood by those within the art that if a specific number of an introduced claim recitation is intended, such an intent will be explicitly recited in the claim, and in absence of such recitation no such intent is present. For example, as an aid to understanding, the following appended claims may contain usage of introductory phrases “at least one” and “one or more” to introduce claim recitations. However, use of such phrases should not be construed to imply that introduction of a claim recitation by indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”). The same holds true for use of definite articles used to introduce claim recitations. In addition, even if a specific number of an introduced claim recitation is explicitly recited, those skilled in the art will recognize that such recitation should typically be interpreted to mean at least the recited number (e.g., a bare recitation of “two recitations,” without other modifiers, typically means at least two recitations, or two or more recitations). It will be further understood by those within the art that virtually any disjunctive word and/or phrase presenting two or more alternative terms, whether in the description, claims, or drawings, should be understood to contemplate possibilities of including one of the terms, either of the terms, or both terms. For example, phrase “A or B” will be understood to include possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

A further effect or variation can readily be derived by a person skilled in the art. Hence, a broader aspect of the present disclosure's not limited to particular detailed and representative embodiments illustrated and described above. Therefore, various modifications are possible without departing from the spirit or scope of a general inventive concept that is defined by the appended claims and equivalents thereof.

1. A mounting device for mounting an audio speaker including a mounting plate in a vehicle, comprising:
an engaging plate;
a first engaging member disposed on a first side of the engaging plate, the first engaging member including a longitudinal threaded groove; and
a second engaging member disposed on a second side of the engaging plate, the second engaging member including opposite locking ribs, the second engaging member including a channel.

2. The mounting device as claimed in claim 1, wherein the mounting device is secured with a speaker frame by the first engaging member through a screw being tightened in the threaded groove.

3. The mounting device as claimed in claim 1, wherein the second engaging member is configured to pass through a fixing hole on the mounting plate.

4. The mounting device as claimed in claim 1, wherein the locking ribs include a base region and a free end, and the locking ribs extend outwards upwardly from a far end of the second engaging member towards the engaging plate.

5. The mounting device as claimed in claim 3, wherein the locking ribs are configured to elastically deform for passing through the fixing hole and be elastically restored.

6. The mounting device as claimed in claim 1, wherein the channel is provided to drain out water accumulating around the mounting device.

7. A speaker assembly comprising:
the speaker mounting device for mounting an audio speaker as claimed in claim 1.

8. A clip comprising:
an engaging plate;
a first engager provided on a first side of the engaging plate;
a first lock provided at an end of the first engager on an side opposite to the engaging plate;
a second engager provided on a second side that is opposite to the first side of the engaging plate; and
a second lock provided at an end of the second engager on a side opposite to the engaging plate.

9. A device for mounting an audio speaker in a vehicle, comprising:
the clip according to claim 8; and
a pin, wherein:
the pin includes a shaft; and
the first engager includes a concave portion that receives the shaft of the pin.

10. The device according to claim 9, wherein the pin further includes a concave portion capable of putting the first lock therein and thereby elastically deforming the first lock.

11. A method of mounting an audio speaker in a vehicle, comprising:
inserting a first engager provided on an engaging plate of a clip into a hole provided on a frame plate of the audio speaker to engage the engaging plate with a first side of the frame plate and engage a first lock provided at an end of the first engager on a side opposite to the engaging plate with a second side of the frame plate; and
inserting a second engager provided on the engaging plate of the clip into a hole provided on a body panel of the vehicle to engage the engaging plate with a first side of the body panel and engage a second lock provided at an end of the second engager on a side opposite to the engaging plate with a second side of the body panel.

12. The method according to claim 11, further comprising:
a step of inserting a shaft of a pin into a concave portion provided on the first engager of the clip to hold the first lock.

13. A method of mounting a clip on an audio speaker, comprising:
inserting a first engager provided on an engaging plate of a clip into a hole provided on a frame plate of the audio speaker to engage the engaging plate with a first side of the frame plate and engage a first lock provided at an end of the first engager on a side opposite to the engaging plate with a second side of the frame plate.

14. The method according to claim 13, further comprising:
inserting a shaft of a pin into a concave portion provided on the first engager of the clip to hold the first lock.

15. A method of removing an audio speaker from a vehicle, comprising:
releasing engagement of a first lock provided at an end of a first engager provided on a clip with a frame plate of the audio speaker;
pulling the first engager of the clip from a hole provided on the frame plate of the audio speaker;
releasing engagement of a second lock provided at an end of a second engager provided on the clip with a body panel of the vehicle; and
pulling the second engager of the clip from a hole provided on the body panel of the vehicle.

16. The method according to claim 15, wherein the releasing engagement of the first lock includes:
pulling a shaft of a pin inserted into a concave portion provided on the first engager provided on the clip from the concave portion provided on the first engager; and
pushing a concave portion provided on the pin against the first lock provided at the end of the first engager to put the first lock in the concave portion provided on the pin and elastically deform the first lock.

17. A method of removing a clip from an audio speaker, comprising:
releasing engagement of a first lock provided at an end of a first engager provided on the clip with a frame plate of the audio speaker; and
pulling the first engager of the clip from a hole provided on the frame plate of the audio speaker.

18. The method according to claim 17, wherein the releasing engagement of the first lock includes:
pulling a shaft of a pin inserted into a concave portion provided on the first engager provided on the clip from the concave portion provided on the first engager; and
pushing a concave portion provided on the pin against the first lock provided at the end of the first engager to put the first lock in the concave portion provided on the pin and elastically deform the first lock.
